(19) United States
(12) Patent Application Publication
(10) Pub. No.: US 2026/0005835 A1
(43) Pub. Date: Jan. 1, 2026

(54) INSTRUCTION TO ACCELERATE HASH PROCESSING

(71) Applicant: INTERNATIONAL BUSINESS MACHINES CORPORATION, Armonk, NY (US)

(72) Inventors: Rajat RAO, Bangalore (IN); Jonathan D. BRADBURY, Poughkeepsie, NY (US); Timothy J SLEGEL, Staatsburg, NY (US); Görkem KILINÇ, Sindelfingen (DE); Louis P. GOMES, Poughkeepsie, NY (US)

(21) Appl. No.: 18/756,603

(22) Filed: Jun. 27, 2024

(51) Int. Cl. H04L 9/06

(52) U.S. Cl. CPC H04L 9/0643

(57) ABSTRACT

An instruction is executed to generate a message digest for a message. The message digest is to be used in authentication of the message. Executing the instruction includes obtaining from the instruction a control indicator and determining, based on the control indicator, an initial chaining value to be used to generate the message digest. The message digest is generated using the initial chaining value and the message digest is provided to be used in the authentication of the message.

### BACKGROUND

One or more aspects relate, in general, to cryptographic processing within a computing environment, and in particular, to cryptographic hash functions.

Cryptography is used for the protection of data. There are a number of cryptographic functions, including various cryptographic hash functions, such as SHA-3 (Secure Hash Algorithm 3) and SHAKE (SHA Keccak), as examples, that may be used to protect data. SHAKE is a variable length hash function that is based on the Keccak algorithm.

### SUMMARY

Shortcomings of the prior art are overcome, and additional advantages are provided through the provision of a computer program product. The computer program product includes a set of one or more computer-readable storage media and program instructions, collectively stored in the set of one or more computer-readable storage media, for causing at least one computing device to perform computer operations. The computer operations include executing an instruction to generate a message digest for a message. The message digest is to be used in authentication of the message. Executing the instruction includes obtaining from the instruction a control indicator and determining, based on the control indicator, an initial chaining value to be used to generate the message digest. The message digest is generated using the initial chaining value and the message digest is provided to be used in the authentication of the message.

In one or more aspects, a computer program product is provided. The computer program product includes a set of one or more computer-readable storage media and program instructions, collectively stored in the set of one or more computer-readable storage media, for causing at least one computing device to perform computer operations. The computer operations include executing an instruction to generate a message digest for a message. The instruction includes a flags field having at least one control indicator, an address of the message, and a function code to specify a function of the instruction to be performed. The function is a specific hash technique to generate the message digest. The message digest is to be used in authentication of the message. Executing the instruction includes obtaining from the instruction a control indicator of the at least one control indicator. Based on the control indicator, determining an initial chaining value to be used to generate the message digest for the message specified by the instruction. The message digest is generated using the initial chaining value. The message digest is provided to be used in the authentication of the message.

Computer-implemented methods, computer systems and computer program products relating to one or more aspects are described and claimed herein. Each of the embodiments of the computer program product may be embodiments of each computer system and/or each computer-implemented method and vice-versa. Further, each of the embodiments is separable and optional from one another. Moreover, embodiments may be combined with one another. Each of the embodiments of the computer program product may be combinable with aspects and/or embodiments of each computer system and/or computer-implemented method, and vice-versa. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to incorporate and use one or more aspects of the present disclosure;

FIG. 2 depicts one example of further details of a processor of the processor set of FIG. 1, in accordance with one or more aspects of the present disclosure;

FIG. 3 depicts one example of input to be provided to an accelerator to produce a hash result;

FIG. 4A depicts one example of hash processing;

FIG. 4B depicts one example of hash processing, in accordance with one or more aspects of the present disclosure;

FIG. 5A depicts one example of the hash processing acceleration code of FIG. 1, in accordance with one or more aspects of the present disclosure;

FIG. 5B depicts one example of the execute instruction code of the hash processing acceleration code of FIG. 5A, in accordance with one or more aspects of the present disclosure;

FIG. 6A depicts one example of a format of a Compute Last Message Digest instruction, in accordance with one or more aspects of the present disclosure;

FIGS. 6B-6E depict examples of contents of registers used by the Compute Last Message Digest instruction of FIG. 6A, in accordance with one or more aspects of the present disclosure;

FIGS. 6F-6G depict examples of contents of general registers used by the Compute Last Message Digest instruction of FIG. 6A, in accordance with one or more aspects of the present disclosure;

FIG. 6H depicts one example of a parameter block used by the Compute Last Message Digest instruction of FIG. 6A, in accordance with one or more aspects of the present disclosure;

FIG. 7A depicts one example of operations of Compute Intermediate Message Digest-SHAKE processing, in accordance with one or more aspects of the present disclosure;

FIG. 7B depicts one example of padding operations of Compute Last Message Digest-SHAKE processing, in accordance with one or more aspects of the present disclosure;

FIG. 7C depicts one example of extended output function operations of Compute Last Message Digest-SHAKE processing, in accordance with one or more aspects of the present disclosure;

FIGS. 7D-7E depict one example of a Secure Hash Algorithm (SHA-3)-224 processing, in accordance with one or more aspects of the present invention;

FIG. 8 depicts one example of hash processing acceleration code processing, in accordance with one or more aspects of the present disclosure;

FIGS. 9A-9B depicts one example of using selected control indicators in Compute Last Message Digest-SHAKE processing, in accordance with one or more aspects of the present disclosure; and

FIGS. 10A-10B depict another example of a computing environment to incorporate and use one or more aspects of the present disclosure.

### DETAILED DESCRIPTION

In accordance with one or more aspects of the present disclosure, a capability is provided to facilitate processing within a computing environment by, for instance, accelerating hash processing. In one or more aspects, hash processing is accelerated by providing an instruction (e.g., a single architected instruction) to perform the hash processing using inputs of the instruction that selectively control aspects of the hash processing. Further, in one or more aspects, hash processing is accelerated by allowing the instruction to be interrupted and then resumed from where it was interrupted using saved state of the instruction. This is in contrast to repeating the hash processing or having to separately determine, external to the instruction, where the hash processing was interrupted and where it should be resumed.

In one or more aspects, a single instruction (e.g., a compute message digest instruction, such as a compute last message digest instruction, other compute message digest instructions, or other instructions) is provided that encodes parameters and/or other input to be used for hash processing. The single instruction is interruptible and includes the state to be used to resume hash processing. The single instruction is executed in hardware (e.g., using at least one hardware accelerator), in one example. In one or more aspects, interruptible hash processing is implemented which saves state information, such as, e.g., a chaining value, to be used to resume interrupted processing.

In one or more aspects, a format of the instruction (e.g., a compute message digest instruction, such as a compute last message digest instruction, other compute message digest instructions, or other instructions) includes one or more parameters and/or other input, such as, for instance, an initial chaining value and other inputs, such as one or more control indicators (also referred to as flags). Additional, fewer and/or other parameters and/or inputs may be used. The instruction uses state information (e.g., a chaining or sequencing value) to allow interruption and resuming of the hash processing.

In one or more aspects, hash processing is accelerated by using, e.g., at least one hardware accelerator that is able to perform a plurality of operations of the instruction and/or the hash processing.

In one or more aspects, a computer program product is provided. The computer program product includes a set of one or more computer-readable storage media and program instructions, collectively stored in the set of one or more computer-readable storage media, for causing at least one computing device to perform computer operations. The computer operations include executing an instruction to generate a message digest for a message. The message digest is to be used in authentication of the message. Executing the instruction includes obtaining from the instruction a control indicator and determining, based on the control indicator, an initial chaining value to be used to generate the message digest. The message digest is generated using the initial chaining value and the message digest is provided to be used in the authentication of the message. By including a control indicator in the instruction to be used to determine the initial chaining value performance is improved by enabling selective processing relating to the initial chaining value.

Additionally, or alternatively, in one example, the determining the initial chaining value includes checking the control indicator and using a program provided initial chaining value as the initial chaining value, based on the control indicator being a selected value. By using the control indicator, the determining the initial chaining value is selectively controlled. The control indicator set to the selected value enables backwards compatibility since the initial chaining value may continue to be read from an input buffer, if desired.

Additionally, or alternatively, in one example, the determining the initial chaining value includes using a default value as the initial chaining value, based on the control indicator being another selected value. By using the control indicator, the determining the initial chaining value is selectively controlled. By selectively using a default value instead of reading the value from an input buffer, resources and processing cycles are saved, thereby improving performance.

Additionally, or alternatively, in one example, the message digest is an intermediate message digest for the message. By using the control indicator to determine the initial chaining value to be used to generate intermediate message digests, improvements in performance of the generation of intermediate message digests are provided.

Additionally, or alternatively, in one example, the message digest is a last message digest for the message. As examples, the last message digest may be an extended message digest if extended output function processing is performed or the final message digest provided if no extended output function processing is performed. The control indicator used to determine the initial chaining value may be used for generating last message digests, as well as intermediate message digests. This offers improvements in performance for the generation of message digests.

Additionally, or alternatively, in one example, the executing the instruction further includes controlling a storing of at least a part of an output chaining value produced in generating the last message digest based on another control indicator of the instruction. The use of another control indicator to selectively control the storing of at least a part of the output chaining value improves performance by providing a choice of whether the storing is to be performed. By not performing the storing in select situations, resources and processing cycles are saved and performance is improved.

Additionally, or alternatively, in one example, the controlling the storing of the at least a part of the output chaining value includes selectively bypassing a storing the at least a part of the output chaining value based on the another control indicator being set to a selected value. This improves performance by bypassing storing, which saves resources and processing cycles.

Additionally, or alternatively, in one example, the controlling the storing of the at least a part of the output chaining value includes storing the at least a part of the output chaining value based on the another control indicator being set to another selected value. By using the another control indicator the storing is selectively performed which provides backwards compatibility for programs that wish to store the at least a part of the output chaining value.

Additionally, or alternatively, in one example, the computer operations further include interrupting execution of the instruction and resuming execution of the instruction using at least one selected input of the instruction. This improves performance by enabling the instruction to be interrupted and then resumed at a point of the interruption. This saves processing cycles, time and resources by not requiring the instruction to be repeated from the beginning.

Additionally, or alternatively, in one example, the at least one selected input is an output chaining value that is provided as an input to the instruction. By using the output chaining value as an input to the re-execution of the instruction, the instruction may be restarted from where it was interrupted, saving processing cycles and improving performance.

In accordance with one or more aspects, each of the embodiments is separable and optional from one another. Further, embodiments may be combined with one another.

In one or more aspects, a computer system is provided. The computer system includes at least one computing device, a set of one or more computer-readable storage media, and program instructions, collectively stored in the set of one or more compute-readable storage media, for causing the at least one computing device to perform computer operations. The computer operations include executing an instruction to generate a message digest for a message. The message digest is to be used in authentication of the message. Executing the instruction includes obtaining from the instruction a control indicator and determining, based on the control indicator, an initial chaining value to be used to generate the message digest. The message digest is generated using the initial chaining value and the message digest is provided to be used in the authentication of the message. By including a control indicator in the instruction to be used to determine the initial chaining value performance is improved by enabling selective processing relating to the initial chaining value.

Additionally, or alternatively, in one example, the determining the initial chaining value includes checking the control indicator and using a program provided initial chaining value as the initial chaining value, based on the control indicator being a selected value. By using the control indicator, the determining the initial chaining value is selectively controlled. The control indicator set to the selected value enables backwards compatibility since the initial chaining value may continue to be read from an input buffer, if desired.

Additionally, or alternatively, in one example, the determining the initial chaining value includes using a default value as the initial chaining value, based on the control indicator being another selected value. By using the control indicator, the determining the initial chaining value is selectively controlled. By selectively using a default value instead of reading the value from an input buffer, resources and processing cycles are saved, thereby improving performance.

Additionally, or alternatively, in one example, the message digest is an intermediate message digest for the message. By using the control indicator to determine the initial chaining value to be used to generate intermediate message digests, improvements in performance of the generation of intermediate message digests are provided.

Additionally, or alternatively, in one example, the message digest is a last message digest for the message. As examples, the last message digest may be an extended message digest if extended output function processing is performed or the final message digest provided if no extended output function processing is performed. The control indicator used to determine the initial chaining value may be used for generating last message digests, as well as intermediate message digests. This offers improvements in performance for the generation of message digests.

Additionally, or alternatively, in one example, the executing the instruction further includes controlling a storing of at least a part of an output chaining value produced in generating the last message digest based on another control indicator of the instruction. The controlling the storing of the at least a part of the output chaining value includes selectively bypassing a storing the at least a part of the output chaining value based on the another control indicator being set to a selected value. The use of another control indicator to selectively control the storing of at least a part of the output chaining value improves performance by providing a choice of whether the storing is to be performed. By not performing the storing in select situations, resources and processing cycles are saved and performance is improved.

Additionally, or alternatively, in one example, the executing the instruction further includes controlling a storing of at least a part of an output chaining value produced in generating the last message digest based on another control indicator of the instruction. The controlling the storing of the at least a part of the output chaining value includes storing the at least a part of the output chaining value based on the another control indicator being set to another selected value. By using the another control indicator the storing is selectively performed which provides backwards compatibility for programs that wish to store the at least a part of the output chaining value.

In accordance with one or more aspects, each of the embodiments is separable and optional from one another. Further, embodiments may be combined with another.

In one or more aspects, a computer-implemented method is provided. The computer-implemented method includes executing an instruction to generate a message digest for a message. The message digest is to be used in authentication of the message. Executing the instruction includes obtaining from the instruction a control indicator and determining, based on the control indicator, an initial chaining value to be used to generate the message digest. The message digest is generated using the initial chaining value and the message digest is provided to be used in the authentication of the message. By including a control indicator in the instruction to be used to determine the initial chaining value, performance is improved by enabling selective processing relating to the initial chaining value.

Additionally, or alternatively, in one example, the determining the initial chaining value includes checking the control indicator and using a program provided initial chaining value as the initial chaining value, based on the control indicator being a selected value. By using the control indicator, the determining the initial chaining value is selectively controlled. The control indicator set to the selected value enables backwards compatibility since the initial chaining value may continue to be read from an input buffer, if desired.

Additionally, or alternatively, in one example, the determining the initial chaining value includes using a default value as the initial chaining value, based on the control indicator being another selected value. By using the control indicator, the determining the initial chaining value is selectively controlled. By selectively using a default value instead of reading the value from an input buffer, resources and processing cycles are saved, thereby improving performance.

Additionally, or alternatively, in one example, the message digest is an intermediate message digest for the message. By using the control indicator to determine the initial chaining value to be used to generate intermediate message digests, improvements in performance of the generation of intermediate message digests are provided.

Additionally, or alternatively, in one example, the message digest is a last message digest for the message. As examples, the last message digest may be an extended message digest if extended output function processing is performed or the final message digest provided if no extended output function processing is performed. The control indicator used to determine the initial chaining value may be used for generating last message digests, as well as intermediate message digests. This offers improvements in performance for the generation of message digests.

Additionally, or alternatively, in one example, the executing the instruction further includes controlling a storing of at least a part of an output chaining value produced in generating the last message digest based on another control indicator of the instruction. The use of another control indicator to selectively control the storing of at least a part of the output chaining value improves performance by providing a choice of whether the storing is to be performed. By not performing the storing in select situations, resources and processing cycles are saved and performance is improved.

In accordance with one or more aspects, each of the embodiments is separable and optional from one another. Further, embodiments may be combined with another.

In one or more aspects, a computer program product is provided. The computer program product includes a set of one or more computer-readable storage media, and program instructions, collectively stored in the set of one or more computer-readable storage media, for causing at least one computing device to perform computer operations. The computer operations include executing an instruction to generate a message digest for a message. The instruction includes a flags field having at least one control indicator, an address of the message, and a function code to specify a function of the instruction to be performed. The function is a specific hash technique to generate the message digest. The message digest is to be used in authentication of the message. Executing the instruction includes obtaining from the instruction a control indicator of the at least one control indicator. Based on the control indicator, determining an initial chaining value to be used to generate the message digest for the message specified by the instruction. The message digest is generated using the initial chaining value. The message digest is provided to be used in the authentication of the message. By including a control indicator in the instruction to be used to determine the initial chaining value performance is improved by enabling selective processing relating to the initial chaining value.

In accordance with one or more aspects, each of the embodiments is separable and optional from one another. Further, embodiments may be combined with another.

In one or more aspects, a computer-implemented method is provided. The computer-implemented method includes executing an instruction to generate a message digest for a message. The instruction includes a flags field having at least one control indicator, an address of the message, and a function code to specify a function of the instruction to be performed. The function is a specific hash technique to generate the message digest. The message digest is to be used in authentication of the message. Executing the instruction includes obtaining from the instruction a control indicator of the at least one control indicator. Based on the control indicator, determining an initial chaining value to be used to generate the message digest for the message specified by the instruction. The message digest is generated using the initial chaining value. The message digest is provided to be used in the authentication of the message. By including a control indicator in the instruction to be used to determine the initial chaining value performance is improved by enabling selective processing relating to the initial chaining value.

In accordance with one or more aspects, each of the embodiments is separable and optional from one another. Further, embodiments may be combined with another.

In one or more aspects, a computer program product is provided. The computer program product includes a set of one or more computer-readable storage media and program instructions, collectively stored in the set of one or more computer-readable storage media, for causing at least one computing device to perform computer operations. The computer operations include executing an instruction to generate a message digest for a message. The message digest is to be used in authentication of the message. Executing the instruction includes obtaining from the instruction a control indicator and determining, based on the control indicator, an initial chaining value to be used to generate the message digest. The determining the initial chaining value includes using a default value as the initial chaining value, based on the control indicator being another selected value. The message digest is generated using the initial chaining value and the message digest is provided to be used in the authentication of the message. The message digest is a last message digest for the message. A storing of at least a part of an output chaining value produced in generating the last message digest is controlled based on another control indicator of the instruction. By including a control indicator in the instruction to be used to determine the initial chaining value, performance is improved by enabling selective processing relating to the initial chaining value. By using the control indicator, the determining the initial chaining value is selectively controlled. By selectively using a default value instead of reading the value from an input buffer, resources and processing cycles are saved, thereby improving performance. The control indicator used to determine the initial chaining value may be used for generating last message digests, as well as intermediate message digests. This offers improvements in performance for the generation of message digests. The use of another control indicator to selectively control the storing of at least a part of the output chaining value improves performance by providing a choice of whether the storing is to be performed. By not performing the storing in select situations, resources and processing cycles are saved and performance is improved.

In accordance with one or more aspects, each of the embodiments is separable and optional from one another. Further, embodiments may be combined with another.

In one or more aspects, a computer program product is provided. The computer program product includes a set of one or more computer-readable storage media and program instructions, collectively stored in the set of one or more computer-readable storage media, for causing at least one computing device to perform computer operations. The computer operations include executing an instruction to generate a message digest for a message. The message digest is to be used in authentication of the message. Executing the instruction includes obtaining from the instruction a control indicator and determining, based on the control indicator, an initial chaining value to be used to generate the message digest. The message digest is generated using the initial chaining value and the message digest is provided to be used in the authentication of the message. The message digest is a last message digest for the message. A storing of at least a part of an output chaining value produced in generating the last message digest is controlled based on another control indicator of the instruction. Execution of the instruction is interrupted. Execution of the instruction is resumed using at least one selected input of the instruction. By including a control indicator in the instruction to be used to determine the initial chaining value, performance is improved by enabling selective processing relating to the initial chaining value. The control indicator used to determine the initial chaining value may be used for generating last message digests, as well as intermediate message digests. This offers improvements in performance for the generation of message digests. The use of another control indicator to selectively control the storing of at least a part of the output chaining value improves performance by providing a choice of whether the storing is to be performed. By not performing the storing in select situations, resources and processing cycles are saved and performance is improved. By enabling the instruction to be interrupted and then resumed at a point of the interruption improves performance. This saves processing cycles, time and resources by not requiring the instruction to be repeated from the beginning.

Computer-implemented methods, computer systems and computer program products relating to one or more aspects are described and claimed herein. Each of the embodiments of the computer program product may be embodiments of each computer system and/or each computer-implemented method and vice-versa. Further, each of the embodiments is separable and optional from one another. Moreover, embodiments may be combined with one another. Each of the embodiments of the computer program product may be combinable with aspects and/or embodiments of each computer system and/or computer-implemented method, and vice-versa.

One or more aspects of the present disclosure are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, wearable, mobile, having one node or multiple nodes, having one processor or multiple processors, and/or any other type of environment and/or configuration, etc. that is capable of executing a process (or multiple processes) that performs hash processing including accelerated and/or interruptible hash processing and/or one or more other aspects of the present disclosure. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

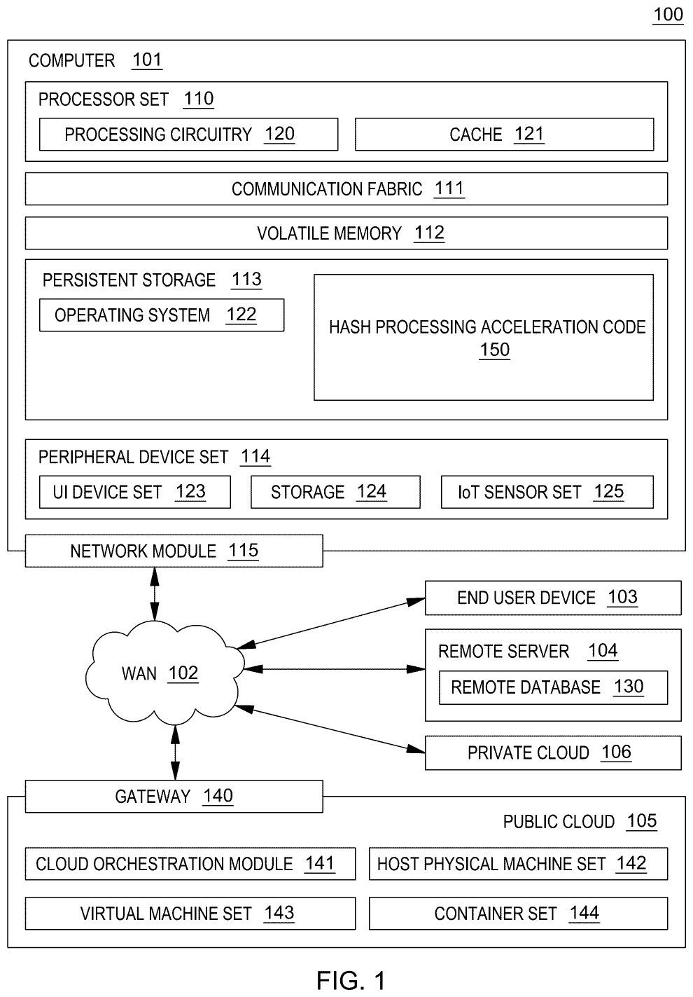

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as hash processing acceleration code 150 (also referred to herein as block 150). In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106, 105 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The computing environment described above is only one example of a computing environment to incorporate, perform and/or use one or more aspects of the present disclosure. Other examples are possible. For instance, in one or more embodiments, one or more of the components/modules/blocks of FIG. 1 are not included in the computing environment and/or are not used for one or more aspects of the present disclosure. Further, in one or more embodiments, additional and/or other components/modules/blocks may be used. Other variations are possible.

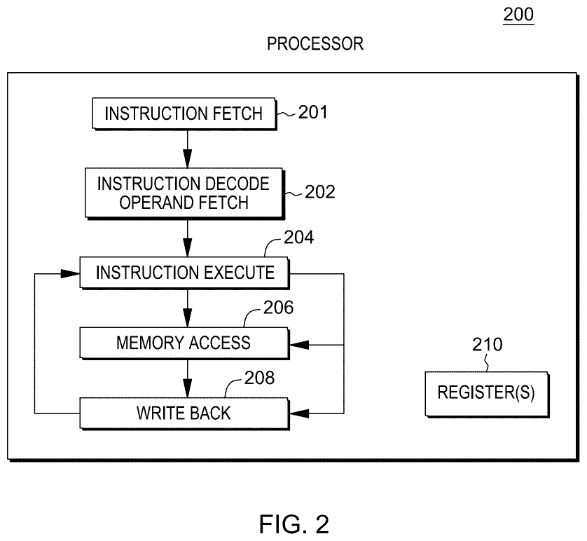

In one example, a processor (e.g., of processor set 110) includes a plurality of functional components (or a subset thereof) used to execute instructions. As depicted in FIG. 2, in one example, a processor 200 includes, for instance, an instruction fetch component 201 to fetch instructions to be executed; an instruction decode/operand fetch component 202 to decode the fetched instructions and to obtain operands of the decoded instructions; one or more instruction execute components 204 to execute the decoded instructions; a memory access component 206 to access memory for instruction execution, if necessary; and a write back component 208 to provide the results of the executed instructions. One or more of the components may access and/or use one or more registers 210 in instruction processing. Further, one or more of the components may access and/or use hash processing acceleration code 150. Additional, fewer and/or other components may be used in one or more aspects of the present disclosure.

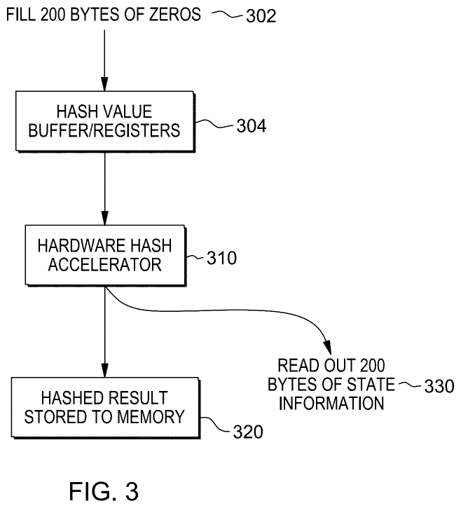

In one example, hash processing is performed to generate a hash (also referred to as a message digest) to be used for authentication of data, such as a message. To generate the hash, a hash function is performed, such as a SHAKE function. In one example, an accelerator is used to perform the function. In such an example, as depicted in FIG. 3, an initial value 302 (e.g., a selected number (e.g., 200 bytes) of zeros) is to be filled into a buffer or register 304. The initial value is output from buffer or register 304 and input into an accelerator 310 that performs hash processing. A result of the hash processing (referred to herein as a hashed result, hash or message digest) is stored 320 in, e.g., memory. Further, in one or more aspects, a selected amount (e.g., 200 bytes) of state information (e.g., a chaining value) is saved 330 and may be used to resume execution based on the hash processing being interrupted. The overhead associated with the set-up (e.g., providing the initial value in the accelerator's buffer/register) and completion (e.g., saving state information) may degrade performance in, at least, certain situations, such as when the hash output is of a selected size (e.g., 100-1000 bytes, as examples; other examples are possible). Thus, in accordance with one or more aspects, the set-up and completion operations are selectively performed, based on one or more control indicators, to provide performance improvements.

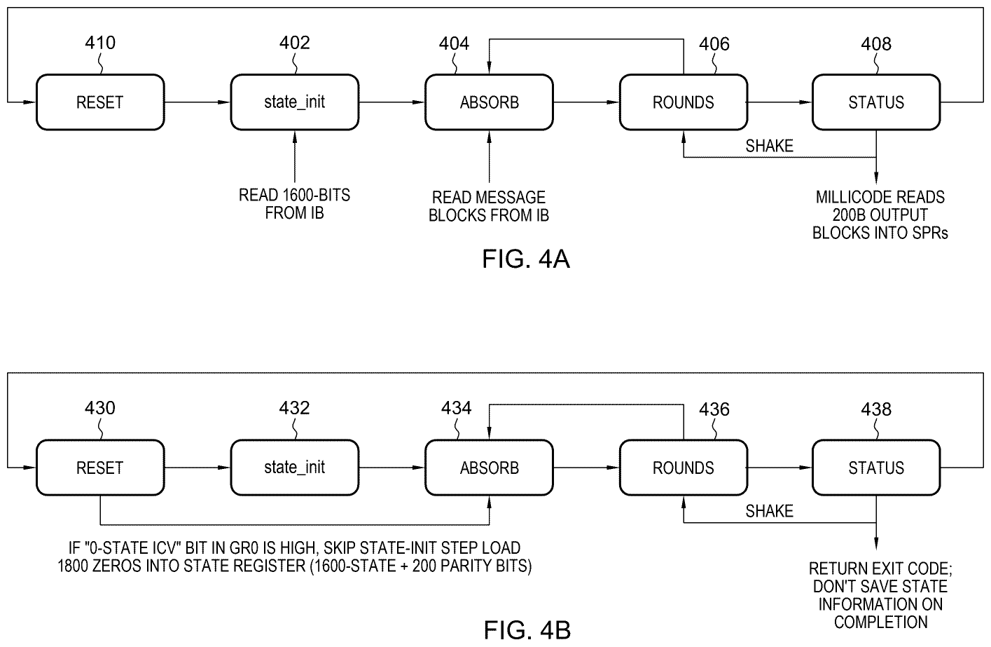

Further details of using hardware (e.g., at least one hardware accelerator) to perform hash processing are described with reference to FIG. 4A. As shown, in one example, in an initial state 402, software provides an initial value to be used in hash processing. For instance, a selected number of zeros, such as 200 bytes of zeros, are read from, e.g., an input buffer and provided to the hardware (e.g., accelerator) for use in hash processing.

In an absorb phase 404, the hardware reads one or more message blocks of a message from an input buffer, and those message blocks are provided to a rounds phase 406, in which SHAKE hash processing is performed to produce at least one hash or message digest. The absorb and rounds processing continues, in one example, for additional message blocks of the message to be read and processed.

At a status phase 408 (e.g., at interruption or completion of the processing and/or interruption or completion of execution of the instruction (e.g., Compute Last Message Digest or other instruction), millicode, in one example, reads a selected amount of output (e.g., 200-byte output blocks)) into one or more special purpose registers. This output is saved state (e.g., a chaining value) that may be used to restart execution of the processing/instruction, if it was interrupted.

Processing may be reset 410, particularly if processing was interrupted. In this case, the saved state (e.g., 200-byte output) is provided as an input to the instruction and to be used in re-execution of the instruction.

As indicated, the overhead of providing the initial value and storing the output may degrade performance. Thus, in accordance with one or more aspects, the processing is optimized by selectively bypassing one or more of the providing the initial value and/or storing the state. An example of this selective processing is described with reference to FIG. 4B.

In one example, as depicted, the reading of the initial value from an input buffer in an initial state 432 may be bypassed. For instance, if a control indicator (described further below) is set to a particular value (e.g., 1; also referred to herein as another selected value), a default value (e.g., a selected number of zeros, such as 200 bytes of zeros, plus a selected number (e.g., 200) parity bits) are loaded into a state register, which are used in absorb phase 434. Absorb phase 434 reads message blocks from the input buffer and provides those message blocks to a rounds phase 436.

In rounds phase 436, SHAKE hash processing is performed to produce at least one hash or message digest. Processing of the absorb and rounds phases continues, in one example, for additional message blocks to be read and processed.

At a status phase 438 (e.g., at completion of the processing and/or completion of execution of the instruction (e.g., Compute Last Message Digest or other instruction)), based on another control indicator (described below) being set to a selected value (e.g., one), the storing or saving of the state information is bypassed.

Processing may be reset 430, particularly if processing was interrupted. In this example, assuming the control indicator is set to bypass reading of the initial state from the input buffer, reset 430 is directly coupled to absorb phase 434.

In one or more aspects, selective performance of one or more operations (e.g., using a default input state rather than reading the input state from an input buffer and/or bypassing the storing of at least a part of a final output chaining value upon successful completion of the instruction) is controlled by one or more control indicators. As an example, the one or more control indicators are used by hash processing acceleration code 150. In one or more aspects, hash processing acceleration code (e.g., hash processing acceleration code 150) includes code or instructions used to perform hash processing, including accelerated and/or interruptible hash processing, and/or other tasks, in accordance with one or more aspects of the present disclosure.

In one example, hash processing acceleration code (e.g., hash processing acceleration code 150) includes code to be used to perform hash processing, including accelerated and/or interruptible hash processing. The code is, e.g., computer-readable program code (e.g., instructions) in computer-readable storage media, e.g., storage (persistent storage 113, cache 121, storage 124, other storage, as examples). The computer-readable storage media may be part of one or more computer program products and the computer-readable program code may be executed by and/or using one or more computing devices (e.g., one or more computers, such as computer(s) 101 and/or other computers; one or more servers, such as remote server(s) 104 and/or other remote servers; one or more devices, such as end user device(s) 103 and/or other end user devices; one or more processors or nodes, such as processor(s) or node(s) of processor set 110 (e.g., processor 200) and/or other processor(s) or node(s); processing circuitry, such as processing circuitry 120 of processor set 110 and/or other processing circuitry; one or more hardware accelerators separate and/or part of one or more processors and/or processing circuitry; and/or other computing devices, etc.). Additional and/or other computers, servers, devices, processors, nodes, processing circuitry, accelerators and/or computing devices may be used to execute the code and/or portions thereof. Many examples are possible.

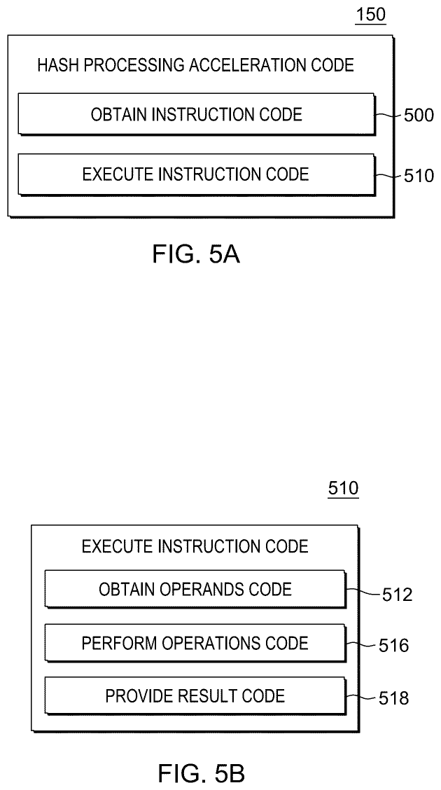

One example of hash processing acceleration code 150 is described with reference to FIG. 5A. In one example, hash processing acceleration code 150 includes obtain instruction code 500 to obtain (e.g., receive, be provided, pull, retrieve, fetch, etc.) an instruction, such as a compute last message digest instruction, other message digest generation instructions and/or other instructions, to perform hash processing, including accelerated and/or interruptible hash processing; and execute instruction code 510 to execute the instruction.

Further details of execute instruction code 510 are described with reference to FIG. 5B. In one example, execute instruction code 510 includes obtain operands code 512 to obtain one or more operands and/or information of the obtained instruction; perform operations code 516 to perform hash processing, including accelerated and/or interruptible hash processing of the instruction; and provide result code 518 to provide a result of the instruction.

Examples of instructions to perform hash processing are a compute last message digest instruction and a compute intermediate message digest instruction; other instructions are also possible. In one example, a compute last message digest instruction, such as a Compute Last Message Digest instruction, or a compute intermediate message digest instruction, such as a Compute Intermediate Message Digest instruction, is a single architected hardware machine instruction at the hardware/software interface. As an example, each instruction is part of an instruction set architecture. One example of an instruction set architecture to incorporate and/or use a compute last message digest instruction, a compute intermediate message digest instruction, other instructions and/or aspects of the present disclosure is the z/Architecture® instruction set architecture offered by International Business Machines Corporation, Armonk, New York. One embodiment of the z/Architecture instruction set architecture is described in a publication entitled, “z/Architecture Principles of Operation,” IBM Publication No. SA22-7832-13, Fourteenth Edition, May 2022, which is hereby incorporated herein by reference in its entirety. The z/Architecture instruction set architecture, however, is only one example architecture; other architectures and/or other types of computing environments of International Business Machines Corporation and/or of other entities/companies may include and/or use one or more aspects of the present disclosure. z/Architecture and IBM are trademarks or registered trademarks of International Business Machines Corporation in at least one jurisdiction.

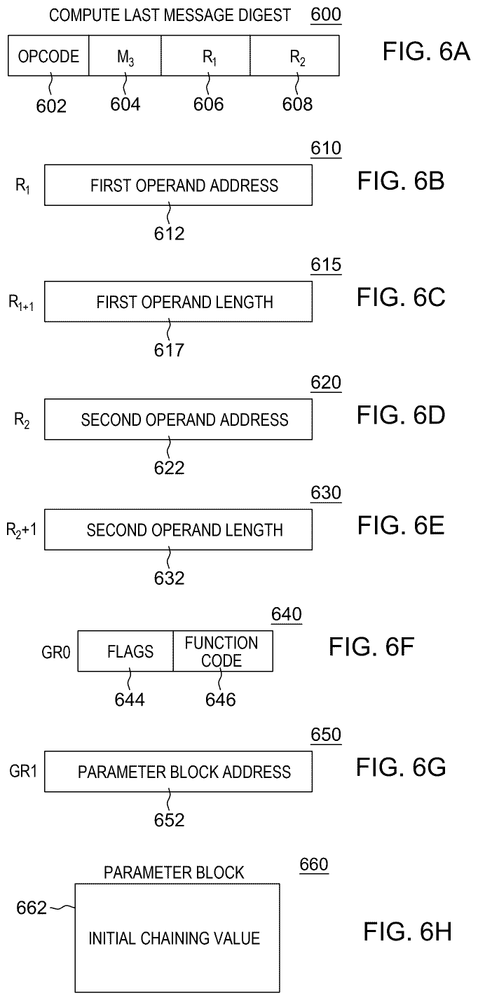

In one example, referring to FIG. 6A, a compute last message digest instruction, such as a Compute Last Message Digest instruction 600, has a format, referred to as a register and register with an extended operation code (opcode) format, having, e.g., 32 bits. The instruction includes, for instance, an operation code field 602 (e.g., bits 0-15); a mask field (M₃) 604 (e.g., bits 16-19); one register field (R₁) 606 (e.g., bits 24-27); and another register field (R₂) 608 (e.g., bits 28-31). Although in this example there is one opcode field 602, in other examples, there may be more than one opcode field. For instance, there may be one opcode field at the beginning of the instruction format and one opcode field at the end of the instruction format. Other examples are also possible.

In one example, when, e.g., the message security assist extension 12 is not installed, bits 16-19, the M₃ field, of the instruction are reserved. In one example, bits 20-23 of the instruction are reserved. Further, in one example, the instruction is configured to perform a plurality of functions, and for certain functions, the R₁ field is reserved. Reserved fields should contain, e.g., zeros; otherwise, the program may not operate compatibly in the future. Although reference is made to one or more message security assist extensions in describing the instruction, in other examples, such a reference is not made and/or other extensions and/or facilities may be referenced. Many examples are possible.

In one example, when the message security assist extension 12 is installed and a selected bit (e.g., bit 0) of the M₃ field is, e.g., one, the flags field is defined in, e.g., bit positions 48-55 of general register 0.

For instance, M₃ field 604 includes:
Flags field valid: The flags field valid indicator (e.g., bit, such as bit 0) controls whether the flags field in general register 0 is valid. When the flags field valid bit is, e.g., zero, the flags field is not valid. When the flags field valid bit is, e.g., one, the flags field is valid.
Bits 1-3 are reserved and should contain zeros; otherwise, the program may not operate compatibly in the future.

In one example, referring to FIGS. 6A and 6B, register field (R₁) 606 specifies a register 610 (R₁) that includes a first operand address 612 of a first operand of the instruction. Referring to FIG. 6C, another register 615 (R₁+1) includes a length 617 of the first operand. In one example, the Compute Last Message Digest instruction is configured to perform a plurality of functions; however, in one example, only particular functions use the R₁ field. For instance, the Compute Last Message Digest-SHAKE-128 function and the Compute Last Message Digest-SHAKE-256 function of the instruction use R₁ field 606; other functions do not use R₁ field 606.

In one example, the R₁ field designates an even-odd pair of general registers and is to designate an even-numbered register other than, e.g., general register 0; otherwise, a specification exception is recognized, in one example. In other examples, other types of registers other than general registers may be used. Further, registers other than even-numbered registers may be designated. Many examples are possible.

In one example, referring to FIGS. 6A and 6D, register field (R₂) 608 specifies a register 620 (R₂) that includes a second operand address 622 of a second operand of the instruction. Referring to FIG. 6E, another register 630 (R₂+1) includes a length 632 of the second operand.

In one example, the R₂ field designates an even-odd pair of general registers and is to designate an even-numbered register other than, e.g., general register 0; otherwise, a specification exception is recognized, in one example. In other examples, other types of registers other than general registers may be used. Further, registers other than even-numbered registers may be designated. Many examples are possible.

In one example, the location of the leftmost byte of the second operand is specified by the contents of the R₂ general register. The number of bytes in the second operand location is specified in, e.g., general register R₂+1.

As part of the operation, the address in general register R₂ is incremented by the number of bytes processed from the second operand, and the length in general register R₂+1 is decremented by the same number. The formation and updating of the addresses and length is dependent on, for instance, the addressing mode.

In, for instance, the 24-bit addressing mode, the contents of bit positions 40-63 of general register R₂ constitute the address of the second operand, and the contents of bit positions 0-39 are ignored; bits 40-63 of the updated address replace the corresponding bits in general register R₂, carries out of, e.g., bit position 40 of the updated address are ignored, and the contents of bit positions 32-39 of general register R₂ are set to, e.g., zeros. In the 31-bit addressing mode, the contents of bit positions 33-63 of general register R₂ constitute the address of the second operand, and the contents of bit positions 0-32 are ignored; bits 33-63 of the updated address replace the corresponding bits in general register R₂, carries out of, e.g., bit position 33 of the updated address are ignored, and the content of bit position 32 of general register R₂ is set to, e.g., zero. In the 64-bit addressing mode, the contents of bit positions 0-63 of general register R₂ constitute the address of the second operand; bits 0-63 of the updated address replace the contents of general register R₂, and carries out of, e.g., bit position 0 are ignored. Other examples are possible.

In both the 24-bit and the 31-bit addressing modes, the contents of bit positions 32-63 of general register R₂+1 form a 32-bit unsigned binary integer which specifies the number of bytes in the second operand; and the updated value replaces the contents of bit positions 32-63 of general register R₂+1. In the 64-bit addressing mode, the contents of bit positions 0-63 of general register R₂+1 form a 64-bit unsigned binary integer which specifies the number of bytes in the second operand; and the updated value replaces the contents of general register R₂+1.

In the 24-bit or 31-bit addressing mode, the contents of bit positions 0-31 of general registers R₂ and R₂+1, remain unchanged, in one example.

Further, in one example, Compute Last Message Digest instruction 600 uses multiple implied general registers, such as general register 0 (GR0) and general register 1 (GR1). These registers are referred to as implied registers since they are not explicitly referenced by one or more fields of the instruction; however, they are used by the instruction. Examples of the registers are described below.

In one example referring to FIG. 6F, a general register 0 (640) includes, for instance:
Flags 644 (e.g., bits 48-55): In one example, bit positions 48-55 of general register 0 contain an 8-bit flags field controlling an operation of the function. The flags field and/or certain flags is/are meaningful for selected function codes of the instruction, as described herein. In one example, bits 0-6 are meaningful when, e.g., a message security assist extension 12 is installed, bit 0 of the M₃ field is, e.g., one, and the function code in bits 57-63 of general register 0 designates a specific function (as described with reference to the flags). Bit 7 is meaningful when, e.g., the message security assist extension 6 is installed, and the function code in bits 57-63 of general register 0 designates a specific function (as described with reference to the flags). Any bit of the flags field that is not applicable to the specified function is reserved and should contain a zero; otherwise, the program may not operate compatibly in the future.
Although one or more message security assist extensions are mentioned, in other examples, one or more of these extensions may not be considered for flag control, and/or other functions and/or facilities may be considered. Many examples are possible.
One example format of the flags field is as follows:
   No-ICV Provided (NIP): In one example, bit 0 of the flags field indicates whether the initial chaining value (ICV) value is provided by the program in the parameter block. The No-ICV Provided flag is meaningful, e.g., when the function code in bits 57-63 of general register 0 of the Compute Last Message Digest instruction designates, e.g., a SHA-3 or SHAKE function code (e.g., function codes 32-37).
   When the no-ICV provided flag is a selected value (e.g., zero), the initial chaining value provided by the program in the parameter block is used as the initial chaining value; otherwise, if the no-ICV provided flag is another selected value (e.g., one), a default value, such as zeros, in one example, are used as the initial chaining value.
   Discard unneeded final output chaining value (OCV) part (DUFOP): In one example, bit 1 of the flags field indicates whether the unneeded portion of the final output chaining value is saved in the parameter block. The discard unneeded final output chaining value part flag is meaningful, e.g., when the function code in bits 57-63 of general register 0 of the Compute Last Message Digest instruction designates, e.g., a SHA-3 or SHAKE function code (e.g., function codes 32-37).
   When the discard unneeded final output chaining value part flag is a selected value (e.g., one) and the instruction completes with condition code, e.g., 0, the unneeded portion of the final output chaining value is not necessarily saved in the parameter block. For this case, it is model dependent if the unneeded portion of the final output chaining value is saved in the parameter block. When the discard unneeded final output chaining value part flag is another selected value (e.g., zero) and the instruction completes with condition code, e.g., 0, the entire output chaining value is saved in the parameter block.
   In one example, the number of bytes stored versus the unneeded portion, when the discard unneeded final output chaining value part flag is set to, e.g., one and the condition code is, e.g., 0, is dependent on the cryptographic algorithm being used. For instance, for SHA3-256, the 32 leftmost bytes (e.g., 256÷8) of the output chaining value is the resulting message digest that is stored and the other bytes of the output chaining value may be discarded. Similarly, for SHA3-128, the leftmost 28 bytes of the output chaining value are stored and the remaining bytes may be discarded; for SHA3-384, the leftmost 48 bytes are stored and the remaining bytes may be discarded; and for SHA3-512, the leftmost 64 bytes are stored and the remaining bytes may be discarded. For SHAKE functions, in one example, the output chaining value used in extended output function processing is not stored. Other examples are possible.
   Padding State (PS): In one example, bit 7 of the flags field indicates whether the padding of the second operand has been performed. The padding state flag is meaningful, e.g., when the function code is bits 57-63 of general register 0 of the Compute Last Message Digest instruction designates, e.g., a SHA-3 or SHAKE function code (e.g., function codes 32-37).
   When the padding state flag is, e.g., zero, the padding of the second operand has not yet been performed; otherwise, the padding of the second operand has been performed.
   Reserved: In one example, bits 2-6 of the flags field are reserved and should contain, e.g., zeros; otherwise, the program may not operate compatibly in the future.
General register 0 further includes, for instance:
Function code 646 (e.g., bits 57-63): In one example, bit positions 57-63 of general register 0 include the function code that specifies a function to be performed by the Compute Last Message Digest instruction. The instruction is configured to specify and implement a plurality of functions and respective function codes. Example function codes to be used, in accordance with one or more aspects of the present disclosure, include, for instance, a function code (e.g., function code 32) that specifies a Compute Last Message Digest (KLMD)-SHA3-224 function; a function code (e.g., function code 33) that specifies a Compute Last Message Digest-SHA3-256 function; a function code (e.g., function code 34) that specifies a Compute Last Message Digest-SHA3-384 function; a function code (e.g., function code 35) that specifies a Compute Last Message Digest-SHA3-512 function; a function code (e.g., function code 36) that specifies a Compute Last Message Digest-SHAKE-128 function; and a function code (e.g., function code 37) that specifies a Compute Last Message Digest-SHAKE-256 function, etc. Although example functions and/or function codes may be specified, additional, fewer and/or other functions/function codes may be specified and/or used. Many examples are possible.

Further, in one example, one or more selected bits, e.g., bit 56 of general register 0 is to be, e.g., zero; otherwise, a specification exception is recognized, in one example. Bit positions 0-31 of general register 0 are ignored, in one example. When bit 0 of the M₃ field is, e.g., zero, bit positions 32-55 of general register 0 are ignored. When bit 0 of the M₃ field is, e.g., one, bit positions 32-47 of general register 0 are reserved and are to contain, e.g., zeros; otherwise, the program may not operate compatibly in the future. When bit 0 of the M₃ field is, e.g., one, the flags field of general register 0 contains additional operation controls, as described herein.

In one example, when, for instance, message security assist extension 6 is installed, the padding state flag is defined in bit position 55 of general register 0; otherwise, bit position 55 of general register 0 is ignored.

One example of general register 1 is depicted in FIG. 6G. In one example, a general register 1 (650) includes an address 652 of a parameter block in storage (e.g., memory, storage, etc.). For instance, address 652 is a logical address of, for instance, a leftmost byte of the parameter block in storage. In one example, the location of the address in the general register depends on the addressing mode. For instance, in the 24-bit addressing mode, the contents of bit positions 40-63 of general register 1 constitutes the address, and the contents of bit positions 0-39 are ignored. In the 31-bit addressing mode, the contents of bit positions 33-63 of general register 1 constitute the address, and the contents of bit positions 0-32 are ignored. In the 64-bit addressing mode, the contents of bit positions 0-63 of general register 1 constitute the address. Other examples are possible.

One example of a parameter block used by the Compute Last Message Digest instruction for selected functions is described with reference to FIG. 6H. In one example, a parameter block, e.g., parameter block 660, includes, for instance, an initial chaining value (ICV) 662. The initial chaining value (ICV) represents a 1600-bit state array used by, for instance, the Keccak[c] functions which implement the SHA-3 algorithms.

The parameter block may include additional, fewer and/or other information. Other examples and variations are possible.

In one example, a query function of the instruction provides the means of indicating the availability of other functions of the instruction. The contents of general registers R₁, R₁+1, R₂ and R₂+1 are ignored for the query function, in one example.

For other functions of the instruction, the second operand is processed as specified by the function code using an initial chaining value (ICV) in the parameter block either when the specified function code is not a SHA-3 or SHAKE function, or when the specified function code is a SHA-3 or SHAKE function and the no-initial chaining value provided flag is, e.g., zero, and the result replaces the chaining value. The operation proceeds until the end of the second operand location is reached or a CPU-determined number of bytes have been processed, whichever occurs first.

In one example, for the Compute Last Message Digest-SHAKE functions, when the end of the second operand is reached, an extended output function (XOF) digest is stored at the first operand location. The operation then proceeds until either the end of the first operand location is reached, or a CPU-determined number of bytes have been stored, whichever occurs first.

The result is indicated in the condition code resulting from execution of the instruction.

For the Compute Last Message Digest-SHAKE functions, the following applies, in one example:
A specification exception is recognized, and the operation is suppressed when the padding state (PS), bit 7 of the flags field of general register 0, is, e.g., one and the second operand length is general register R₂+1 is, e.g., nonzero at the beginning of the instruction.
A specification exception is recognized, and the operation is suppressed when the padding state flag is, e.g., one and the no-initial chaining value provided flag is, e.g., one at the beginning of the instruction.
When the remaining second operand length is, e.g., zero, the central processing unit, in one example, inspects the padding state to determine whether padding of the second operand is to be performed. The padding state flag is set to, e.g., one by the central processing unit when padding of the second operand has been performed.
The R₁ field designates an even-odd pair of general registers and is to designate an even-numbered register other than general register 0 and other than general register R₂; otherwise, a specification exception is recognized.
The location of the leftmost byte of the first operand is specified by the contents of general register R₁. The number of bytes in the first operand location is specified in general register R₁+1.
As a part of the operation, the address in general register R₁ is incremented by the number of bytes stored into the first operand, and the length in general register R₁+1 is decremented by the same number. The formation and updating of the address and length is dependent on the addressing mode.
The addressing mode characteristics for general registers R₁ and R₁+1 are the same, in one example, as those for general registers R₂ and R₂+1, respectively, as described herein.

In one example, for functions other than the SHAKE Compute Last Message Digest functions, bit 55 of general register 0 and the R₁ field of the instruction are ignored. In this case, a first operand is not present, and general registers R₁ and R₁+1 are not modified. Other examples are possible.

In operation, a function specified by the function code in general register 0 is performed. One such function is a Compute Last Message Digest-SHAKE-128 function (e.g., function code 36). For the Compute Last Message Digest-SHAKE-128 function, when the length of the second operand in general register R₂+1 is greater than or equal to 168 bytes, the operation is as described with a Compute Intermediate Message Digest-SHAKE-128 function, except that when the remaining second operand length is less than 168 bytes.

In one example, the Compute Intermediate Message Digest instruction has a similar format to the Compute Last Message Digest instruction; however, in one example, the Compute Intermediate Message Digest instruction does not use the padding state flag or the discard unneeded final output chaining value part flag. It may use the no-initial chaining value provided flag.

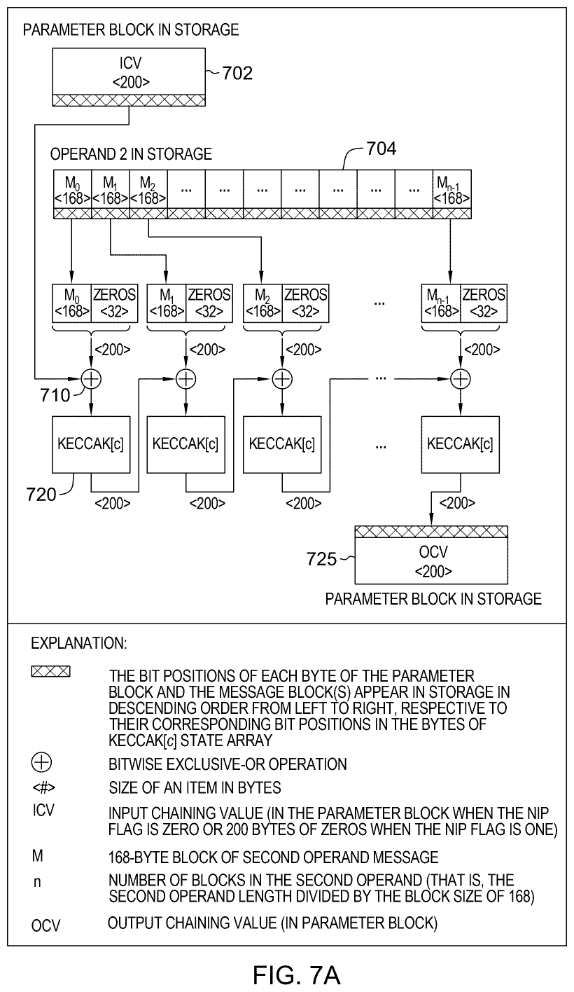

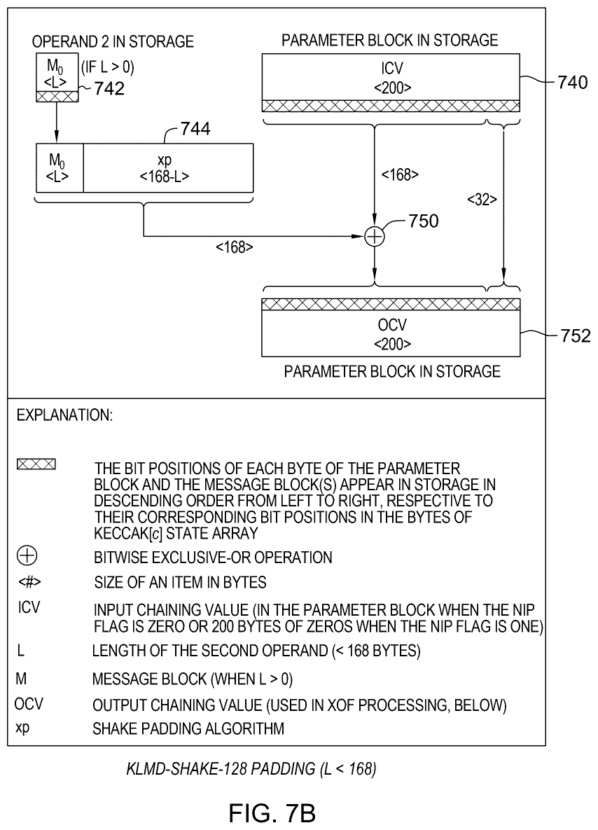

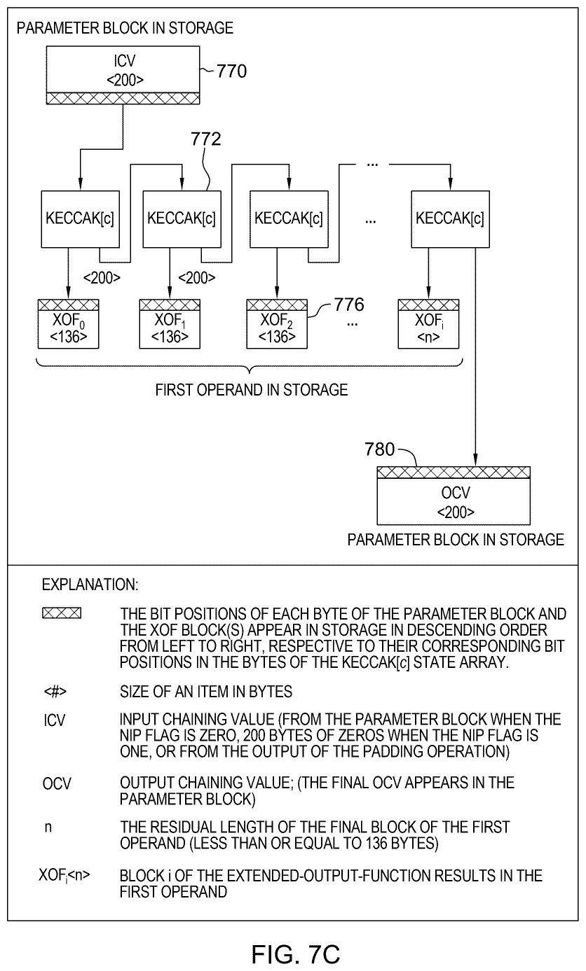

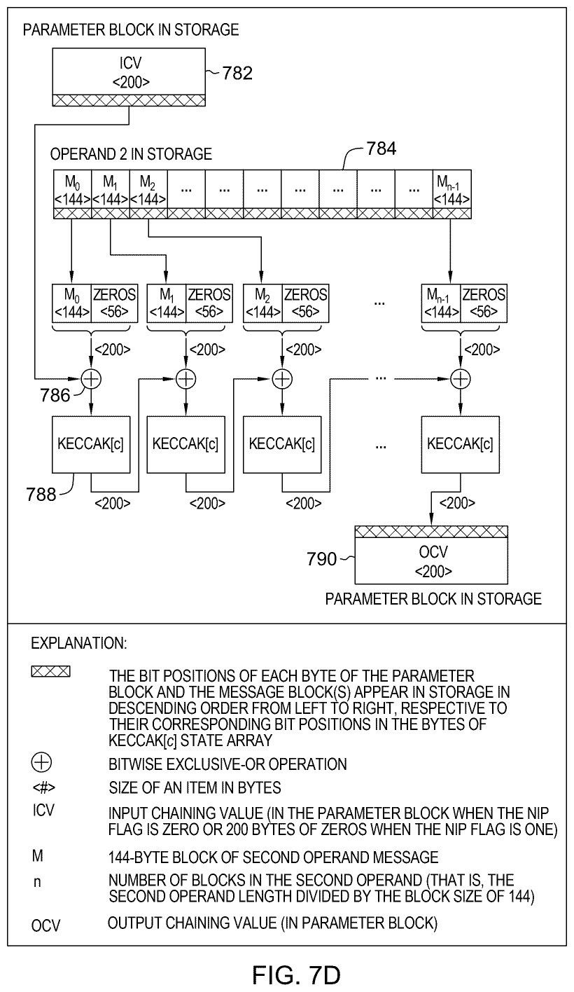

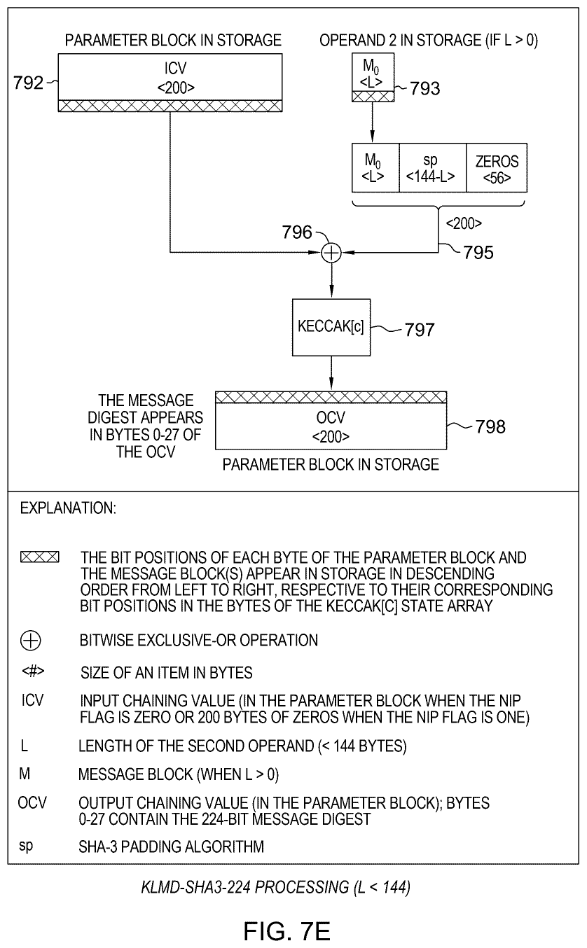

In one example, with the Compute Intermediate Message Digest-SHAKE-128 processing (and thus, the Compute Last Message Digest-SHAKE-128 function), as depicted in FIG. 7A, a 200-byte intermediate message digest 725 is generated for the 168-byte message blocks 704 in operand 2 using, e.g., the Keccak[c] algorithm 720 with the 200-byte initial chaining value in parameter block 702 when the no-initial chaining value provided flag (bit 0 of the flags field in general register 0) is, e.g., zero or with 200 bytes of, e.g., zeros (provided by hardware and not read from the parameter block) when the no-initial chaining value provided flag is, e.g., one. The generated intermediate message digest, also called the output chaining value (OCV), is stored in the chaining value field of the parameter block and the no-initial chaining value provided flag is set to, e.g., zero.

In one example for the Compute Last Message Digest-SHAKE-128 function, when the remaining second operand length is less than 168 bytes, the following processing is performed, in one example:

When the padding state (PS), bit 7 of the flags field of general register 0, is, e.g., zero (indicating that padding has not yet been performed), the following occurs, as depicted in FIG. 7B:
In one example, any remaining bytes 742 of the second operand are padded 744 on the right to form a 168-byte message block. Padding occurs even when there are no remaining bytes in the second operand and does not alter the contents of the second operand. In one example, the padding is performed based on the SHA-3 10*1 padding, in which a binary one is used and then zero or more binary zeros followed by a binary one. Other padding algorithms may be used.
The padding state flag is set to, e.g., one, indicating that padding has been performed.
The second operand address in general register R₂ is incremented by the number of message bytes processed, and the second operand length in general register R₂+1 is set to, e.g., zero.
The 168-byte padded message, is exclusive Ored 750 with the contents of the leftmost 168 bytes of the state array 740 (from the initial chaining value in the parameter block or from the output chaining value resulting from the previous block's processing) when the no-initial chaining value provided flag (bit 0 of the flags field in general register 0) is, e.g., zero or with 168 bytes of zeros (not from the parameter block) when the no-initial chaining value provided flag is, e.g., one to form an output chaining value 752 that is used in the extended output function (XOF) processing and the no-initial chaining value provided flag is set to, e.g., zero. The rightmost 32 bytes, as an example, of the state array are unchanged.

Depending on the number of second operand blocks processed when padding is completed, either (a) the output chaining value is stored into the parameter block, and the instruction completes by setting condition code 3 (partial completion), or (b) the operation continues with extended output function processing, as described below.

When the padding state flag is, e.g., one (indicating that padding has been performed for the message, either by the current or previous execution of the instruction), extended output function processing is performed as depicted in FIG. 7C. For example:
1. If the first operand length in general register R₁+1 is, e.g., zero and the discard unneeded final output chaining value (DUFOP) flag (bit 1 of the flags field in general register 0) is, e.g., zero, then the output chaining value 780 is stored into the parameter block, a counter in a cryptography counter set is updated when appropriate, and the instruction completes with, e.g., condition code 0. If the first operand length in general register R₁+1 is, e.g., zero and the discard unneeded final output chaining value flag is, e.g., one, then the output chaining value is not stored into the parameter block, a counter in the cryptography counter set is updated when appropriate, and the instruction completes with, e.g., condition code 0. If the first operand length is, e.g., zero at the beginning of the instruction, then it is model dependent whether the initial chaining value is fetched from the parameter block and stored back unmodified as the output chaining value when the discard unneeded final output chaining value flag is, e.g., zero.
2. The Keccak[c] function 772 is invoked using the previous output chaining value as input 770 and replacing the output chaining value.
3. General register R₁ contains the current address of the first operand (which includes extended output function (XOF) 776 results), and general register R₁+1 contains the remaining length of the first operand. The number of bytes to be stored, n, is either the remaining first operand length or 168, whichever is smaller.
The first n bytes of the output chaining value are stored at the first operand location.
The first operand address in general register R₁ is incremented by n, and the first operand length general register R₁+1 is decremented by n.

Steps 1-3 of this process are repeated until the first operand length becomes, e.g., zero (in which case, a counter in the cryptography counter set is updated when appropriate and the instruction completes with, e.g., condition code 0) or until a CPU-determined number of bytes have been stored (in which case, the instruction completes with, e.g., condition code 3). The output chaining value is stored into, e.g., bytes 0-199 of the parameter block either when condition code 3 is set or when the discard unneeded final output chaining value flag is, e.g., zero and condition code, e.g., 0 is set.

The contents of the parameter block are unpredictable when, for instance, the discard unneeded final output chaining value flag is, e.g., one and the instruction completes with, e.g., condition code 0.

Other examples of functions that may be specified include, for instance, one or more other SHAKE functions, such as a Compute Last Message Digest-SHAKE-256 function (e.g., function code 37), which is processed similarly to the SHAKE-128 function, except that byte sizes are different (e.g., xp is xp<136-L>, and/or other sizes may be different). Further, various SHA functions may be specified, including, but not limited to, Compute Last Message Digest-SHA3-224, SHA3-256, SHA3-384, SHA3-512) functions (e.g., function codes 32-35). Additional, fewer and/or other functions may also be specified.

One example of processing for a SHA3 function, such as SHA3-224 is described with reference to FIGS. 7D-7E. In one example, referring to FIG. 7D, when the length of the second operand in general register R₂+1 is greater than or equal to, e.g., 144 bytes, then the following processing is performed until the length of the second operand is less than, e.g., 144 bytes: a 200-byte intermediate message digest 790 is generated for the 144-byte message blocks 784 in operand 2 using, e.g., the Keccak[c] algorithm 788 with the 200-byte initial chaining value in parameter block 782 when the no-initial chaining value provided flag (e.g., bit 0 of the flags field in general register 0) is, e.g., zero or with 200 bytes of, e.g., zeros (provided by hardware and not read from the parameter block) when the no-initial chaining value provided flag is, e.g., one. The generated intermediate message digest, also called the output chaining value (OCV), is stored in the chaining value field of the parameter block and the no-initial chaining value provided flag is set to, e.g., zero.

In one example, when the remaining second operand length is less than, e.g., 144 bytes, the following processing is performed:

Referring to FIG. 7E, any remaining bytes of the second operand 793 are padded on the right to form, e.g., a 144-byte message block as described for the symbol “sp<n>”. Padding occurs even when there are no remaining bytes in the second operand and does not alter the contents of the second operand. In one example, the padding is performed based on the SHA-3 10*1 padding. Other padding algorithms may be used.

In one example, a 224-bit (28-bytes) message digest 798 is generated for the padded message block 795 (e.g., 144-byte message block padded with zeros (e.g., 56 zeros)) using the KECCAK [c] algorithm 797 with the 200-byte initial chaining value in the parameter block 792 when the no-initial chaining value part flag (e.g., bit 0 of the flags field in general register 0) is, e.g., zero or with 200 bytes of zeros when the no-initial chaining value part flag is, e.g., one. For instance, the initial chaining value (e.g., from the parameter block or a default value) is exclusive ORed 796 with the 200 byte padded message block 795 and input to KECCAK [c] 797 to produce the 28 byte output chaining value. The message digest is generated regardless of whether the second operand length is, e.g., zero and the no-initial chaining value part flag is set to, e.g., zero. When the discard unneeded final output chaining value part flag (e.g., bit 1 of the flags field in general register 0) is, e.g., zero or the instruction completes with condition code 3, the entire 200-byte output of the KECCAK [c] algorithm, also called the output chaining value (OCV) 798, is stored in the parameter block; otherwise, only, e.g., the leftmost 28 bytes of the output chaining value is stored in the parameter block. The generated message digest is contained in bytes 0-27 of the parameter block. The contents of, e.g., bytes 28-199 of the parameter block is unpredictable when, e.g., the unneeded final output chaining value part flag is, e.g., one and the instruction completes with condition code, e.g., 0.

Although in the examples herein, certain byte sizes are described, other byte sizes may be used in other examples. Further, other size SHA block digest algorithms may be used, as well as other hash or hash-based techniques. Many examples are possible.

In one example, a specification exception is recognized, and no other action is taken if any of the following occurs:
Bit 56 of general register 0 is not zero.
Bits 57-63 of general register 0 specify an unassigned or uninstalled function code.
The R₂ field designates an odd-numbered register or general register 0.
For the KLMD-SHAKE functions, either of the following is true:

The R₁ field designates an odd-numbered register, general register 0 or register R₂.

The second operand length is, e.g., nonzero, and the padding state flag is, e.g., one.

Example resulting condition codes include, for instance: 0 Normal completion; 1--; 2--; 3 Partial completion.

Example program exceptions include, for instance:
Access (fetch, operand 2 and message bit length; fetch and store, chaining value, store, operand 1, cryptography counter)
Operation (if the message-security assist is not installed)
Specification
Transaction constraint

One example of execution priority is indicated below:
1.-6. Exceptions with the same priority as the priority of program-interruption conditions for the general case.
7.A Access exceptions for second instruction halfword.
7.B Operation exception.
7.C Transaction constraint
8a. Specification exception due to invalid function code or invalid register number.
8b Specification exception due to nonzero second operand length when the padding state flag is, e.g., one (SHAKE functions only, in one example).
9. Access exceptions for an access to the parameter block or second operand.
10. Access exceptions for an access to the first operation (SHAKE functions only, in one example).
11. Condition code 3 due to partial completion and one or more units of operation remain to be processed.
12. Access exceptions for an access to a cryptography counter and second operand length initially less than or equal to UopOpLen (micro-operation operation length) for certain SHA functions, including SHA-3, or second and first operand lengths initially less than or equal to micro-operation operation length for SHAKE functions, where micro-operation operation length is the maximum amount of second or first operand processed during a unit of operation.
13. Condition code 3 due to partial completion and second operand length initially less than or equal to micro-operation operation length for, e.g., SHA-3 functions, or second and first operand lengths initially less than or equal to micro-operation operation length for SHAKE functions, where micro-operation operation length is the maximum amount of second or first operand processed during a unit of operation.
14 Condition code 0 due to normal completion.

In one or more aspects, if the program is to frequently test for the availability of a function, it may select to perform the query function once during initialization; subsequently it may examine the stored results of the query function in memory with an instruction such as a Test Under Mask instruction or other instruction.

In one or more aspects, for the Compute Last Message Digest-SHAKE functions, when condition code 3 is set during the extended output function, the first operand address and length in general registers R₁ and R₁+1, respectively, are updated such that the program can simply branch back to the instruction to continue the operation.

For unusual situations, the central processing unit protects against endless reoccurrence for the no-progress case. Thus, the program can safely branch back to the instruction whenever condition code 3 is set with no exposure to an endless loop.

In one or more aspects, the Compute Last Message Digest instruction does not require the second operand to be a multiple of the data block size. It first processes complete blocks and may set, e.g., condition code 3 before processing all blocks. After processing, for instance, all complete blocks, it then performs the padding operation including the remaining portion of the second operand. This may use one or two iterations of the designated block digest algorithm.

In one or more aspects, the Compute Last Message Digest instruction provides the SHA padding for messages that are a multiple of eight bits in length. If a SHA function is to be applied to a bit string which is not a multiple of eight bits, the program is to perform the SHA padding and use, e.g., the Compute Intermediate Message Digest instruction.

In one or more aspects, for the Compute Last Message Digest instruction-SHAKE functions, the following applies:
The padding state (PS), bit 7 of the flags field of general register 0, is to be set to, e.g., zero prior to the first execution of the Compute Last Message Digest instruction for a message, and the padding state is not to be altered by the program for any subsequent executions of Compute Last Message Digest instruction for the same message until normal completion occurs.
If padding of the final (short or null) block of the second operand is performed when the first operand length is, e.g., zero, then the padded block is exclusive ORed with the contents of the state array, the result is stored as the output chaining value in the parameter block when the discard unneeded final output chaining value flag is, e.g., zero, and the instruction completes with, e.g., condition code 0. The Keccak[c] function is not invoked in this case.

In one or more aspects, the Compute Last Message Digest SHA-3 and SHAKE functions perform padding according to the adopted NIST SHA-3 specification, in one example. Software that was designed according to earlier draft SHA-3 specifications can still benefit from the Compute Intermediate Message Digest SHA-3 and SHAKE functions if the software performs the padding of the last message block.

In one or more aspects, for the SHA-3 and SHAKE functions, the entire output chaining value (OCV), in one example, is stored in the parameter block after completing a unit of operation if the instruction does not complete with, e.g., condition code 0 immediately after completing the unit of operation. Other examples are possible.

In the description herein of a compute last message digest instruction, such as Compute Last Message Digest instruction 600, specific locations, specific fields and/or specific sizes of the fields may be indicated (e.g., specific bytes and/or bits). However, other locations, fields and/or sizes may be provided. Further, although the setting of a bit to a particular value, e.g., one or zero, may be specified, this is only an example. The bit, if set, may be set to a different value, such as the opposite value or to another value, in other examples. Many variations are possible.

In one embodiment, the fields of the instruction are separate and independent from one another; however, in other embodiments, more than one field may be combined. Further, although example types of registers are used, other types of registers may be used. Other examples are possible.

An instruction, such as a Compute Last Message Digest instruction, may have additional, fewer and/or other fields. For instance, one or more fields of a message instruction, such as the Compute Last Message Digest instruction, may be optional. Many variations are possible.

Although various examples are provided for one or more formats of the instruction, additional and/or other formats may be used. Further, the processing may be used for other purposes than described herein.

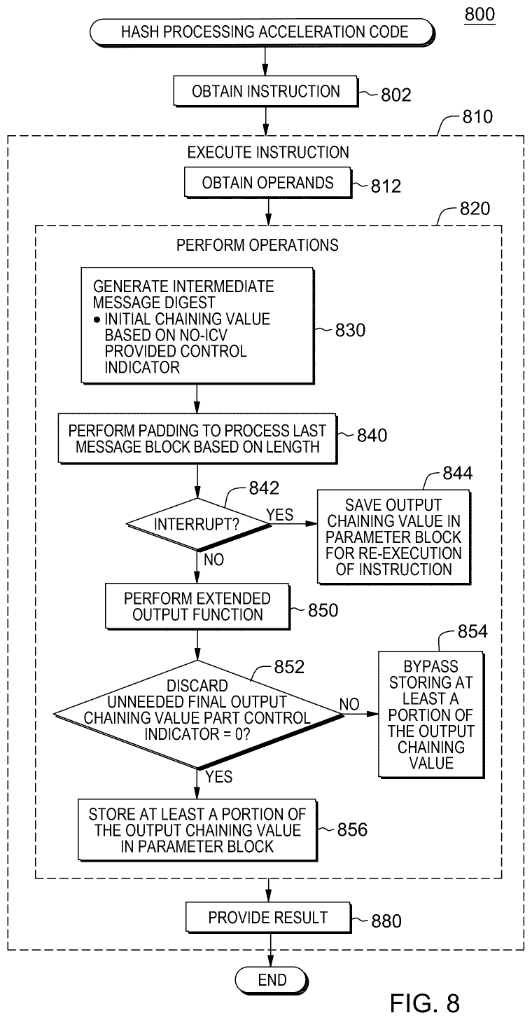

Further details of hash processing, including, but not limited to, accelerated and/or interruptible hash processing, and/or of executing an instruction, such as a Compute Last Message Digest instruction, to perform hash processing, including accelerated and/or interruptible hash processing, are described with reference to FIG. 8. In one example, a hash processing acceleration code process 800 (also referred to as process 800) is executed by one or more computing devices (e.g., one or more computers, such as computer(s) 101 and/or other computers; one or more servers, such as remote server(s) 104 and/or other remote servers; one or more devices, such as end user device(s) 103 and/or other end user devices; one or more processors or nodes, such as processor(s) or node(s) of processor set 110 (e.g., processor 200) and/or other processor(s) or node(s); processing circuitry, such as processing circuitry 120 of processor set 110 and/or other processing circuitry; one or more hardware accelerators separate and/or part of one or more processors and/or processing circuitry; and/or other computing devices, etc.). Additional and/or other computers, servers, devices, processors, nodes, processing circuitry, accelerators and/or computing devices may be used to execute the processing and/or aspects thereof. Many examples are possible.

Referring to FIG. 8, in one example, process 800 obtains 802 an instruction using, e.g., obtain instruction code 500 (FIG. 5A). For instance, process 800 obtains Compute Last Message Digest instruction 500 (FIG. 5A) or another instruction. Process 800 executes 810 the instruction using, e.g., execute instruction code 510.

In one example, in executing the instruction, process 800 obtains 812 one or more operands and/or information of an encoding of the instruction (e.g., using obtain operands code 512). The operands and/or information obtained depends, for instance, on the function or operation to be performed. In one example, process 800 obtains an address of the message (e.g., using R₂), a length of the message (e.g., using R₂+1), one or more flags from flags field 644 of, e.g., general register 0, a function code from function code field 646 of, e.g., general register 0 and an address of a parameter block (e.g., using general register 1). One or more parameters may be obtained from the parameter block, such as one or more chaining values; other examples are possible.

Using one or more of the operands and/or information, process 800 performs 820 a plurality of operations of the instruction, based, e.g., on the function code and using, e.g., perform operations code 516. For instance, process 800 generates 830 an intermediate message digest, as described herein (e.g., see FIG. 7A). The initial chaining value used to generate the intermediate message digest is dependent, for instance, on a control indicator, such as the no-initial chaining value provided control indicator or flag. For instance, if the no-initial chaining value provided flag is set to a selected value (e.g., 0), the program supplies the initial chaining value (e.g., in a parameter block); however, if the no-initial chaining value provided flag is set to another selected value (e.g., 1), a default value (e.g., a selected number of zeros) is provided as the initial chaining value.

Process 800 performs 840 padding, as described herein (see, e.g., FIG. 7B), to process the last message block. This processing depends on the length of the last message block. Process 800 determines 842 whether the processing/instruction has been interrupted. If it has been interrupted, process 800 saves 844 at least a portion of the output chaining value in the parameter block for re-execution of the instruction. However, if the processing/instruction has not been interrupted, process 800 continues with performing 850 an extended output function, an example of which is described herein (see, e.g., FIG. 7C).

Process 800, assuming that the instruction successfully completed (e.g., condition code 0), determines 852 whether the discard unneeded final output chaining value part is set to a selected value (e.g., one). If it is set to the selected value, process 800 bypasses 854 the storing of the at least a portion of the final output chaining value. However, if the discard unneeded final output chaining value part is set to another selected value (e.g., zero), process 800 stores 856 the at least a portion of the final output chaining value in the parameter block.

Based on performing the operations (e.g., generating the intermediate message digest, performing padding, and/or performing the extended output function), process 800 provides 880 a result (e.g., using provide result code 518) of the instruction. The result is, for instance, a hash or message digest that may be used to authenticate the message for which the message digest was generated. For instance, a message and message digest may be sent from one user to another user. The other user generates another message digest for the received message and then compares the generated message digest with the received message digest. If they are equal, then the message is authenticated; otherwise, the message is invalid.

In one or more aspects, the operations, unless interrupted, are executed as part of a single execution of the instruction.

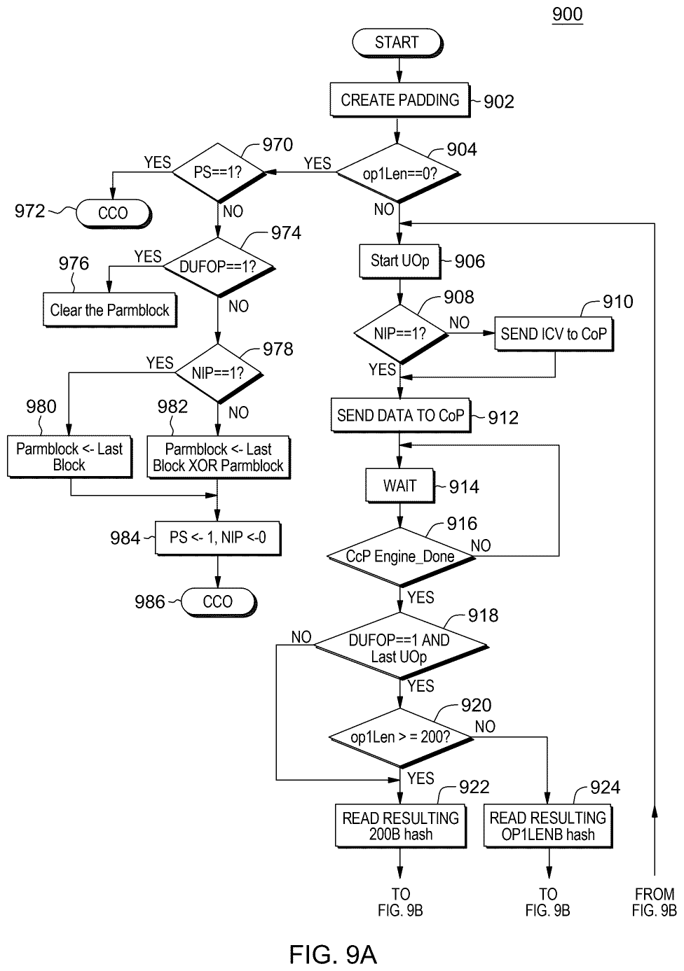

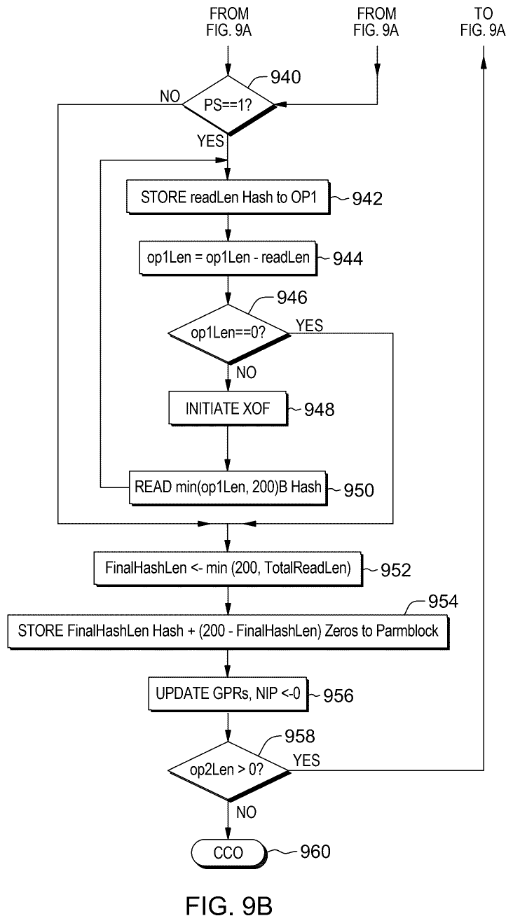

Further details of one or more aspects of the present disclosure are described with reference to FIGS. 9A-9B. For instance, use of various control indicators in controlling execution of the instruction are described. In one example, a process 900 is executed as part of execution of a compute message digest instruction, such as Compute Last Message Digest instruction 600. In one example, process 900 is executed by one or more computing devices (e.g., one or more computers, such as computer(s) 101 and/or other computers; one or more servers, such as remote server(s) 104 and/or other remote servers; one or more devices, such as end user device(s) 103 and/or other end user devices; one or more processors or nodes, such as processor(s) or node(s) of processor set 110 (e.g., processor 200) and/or other processor(s) or node(s); processing circuitry, such as processing circuitry 120 of processor set 110 and/or other processing circuitry; one or more hardware accelerators separate and/or part of one or more processors and/or processing circuitry; and/or other computing devices, etc.). Additional and/or other computers, servers, devices, processors, nodes, processing circuitry, accelerators and/or computing devices may be used to execute the processing and/or aspects thereof. Many examples are possible.

In one example, process 900 creates 902 padding and determines 904 whether a length of operand 1 (op1Len) is a particular value (e.g., zero). If the length of operand 1 is not the particular value, process 900 starts 906 a micro-operation. Process 900 determines 908 whether no-initial chaining value provided flag is set to another selected value (e.g., 1). If the no-initial chaining value flag is not set to the other selected value (e.g., 1) and thus, is set to a selected value (e.g., 0), process 900 sends 910 the initial chaining value to, e.g., a co-processor (e.g., a hardware accelerator).

Thereafter, or if the no-initial chaining value provided is another selected value (e.g., one), process 900 sends 912 data to the co-processor. Process 900 waits 914 until it receives an indication (e.g. signal) that the co-processor has completed processing of the data. If process 900 determines 916 that the co-processor is done, it determines 918 whether discard unneeded final output chaining value is set to a selected value (e.g. one) and whether it is the last micro-operation.

If process 900 determines that discard unneeded final output chaining value is set to a selected value (e.g. one) and it is the last micro-operation, process 900 determines 920 whether the length of operand 1 has a predetermined relationship with a chosen value (e.g., greater than or equal to 200 bytes). If the length of operand 1 is greater than or equal to, e.g., 200 bytes or discard unneeded final output chaining value is not set to a selected value (e.g. one) and it is not the last micro-operation, process 900 reads 922 the resulting hash (e.g., 200 bytes). However, if process 900 determines 920 that the operand 1 length does not have the predetermined relationship with the chosen value (i.e., it is less than, e.g., 200 bytes), process 900 reads 924 the resulting operand 1 length hash value.

Process 900 continues, referring to FIG. 9B, with determining whether the padding state flag is set to a selected value (e.g., one). If the padding state flag is set to, e.g., one, process 900 stores 942 the read length hash to operand 1. Process 900 updates 944 the length of operand 1 by, e.g., subtracting the length read from the operand 1 length.

Process 900 determines 946 whether the length of operand 1 is a selected value (e.g., zero). If process 900 determines that the length of operand 1 is not zero, process 900 initiates 948 an extended output function. Further, process 900 reads 950 the minimum of the length of operand 1 or 200 bytes of hash. Processing continues to step 942.

Further, based on determining the length of operand 1 is the selected value (e.g., zero) (946) or if the padding state is not set to the selected value (940), process 900 sets 952 the final hash length to a minimum of 200 or the total length read.

In one example, process 900 stores 954 the final hash length hash plus (200 bytes minus the final hash length).

Process 900 updates 956 one or more general purpose registers and the no-initial chaining value provided flag, which is, e.g., set to zero.

Process 900 determines 958 whether a length of a second operand has a predefined relationship with a selected value (e.g., greater than zero). If the length of the second operand is greater than, e.g., zero, processing continues to initiate 906 a micro-operation; otherwise, processing ends 960 with, e.g., condition code 0.

Returning to FIG. 9A, if process 900 determines 904 that the length of operand one is, e.g., equal to zero, process 900 determines 970 whether the padding state flag is set to a selected value (e.g., one). If it is set to the selected value, processing is complete and the execution ends 972 with, e.g., a condition code zero.

However, if the padding state flag is not set to the selected value, then process 900 determines 974 whether the discard unneeded final output chaining value part flag is set to a selected value (e.g., one). If it is set to the selected value, process 900 clears 976 the parameter block. However, if the discard unneeded final output chaining value part flag is set to the selected value, process 900 determines 978 if the no-initial chaining value provided flag is set to, e.g., one. If the no-initial chaining value provided flag is set to, e.g., one, process 900 updates 980 the parameter block with the last block (e.g., M₀ concatenated with xp—e.g., 744, FIG. 7B), which is exclusive ORed with zeros (e.g., default when the no-initial chaining value provided flag is, e.g., one); otherwise, process 900 updates 982 the parameter block with the last block (e.g., M₀ concatenated with xp—e.g., 744, FIG. 7B) exclusive ORed with the parameter block.

Process 900 sets 984 the padding state flag to, e.g., one and the no-initial chaining value provided flag to, e.g., zero and terminates 986 the instruction with, e.g., a condition code zero.

In one or more aspects, a capability is provided to improve hash processing by selectively controlling one or more aspects of the processing based on control indicators of the instruction used to perform the hash processing.

In one or more aspects, the instruction includes a flag bit to indicate that hardware initializes the initial hashing state as per the specifications. In one or more aspects, an instruction is architected to compute SHAKE and store the resulting hash to a memory location specified as part of the instruction. In one or more aspects, a SHAKE instruction is architected to have state information that can be read from hardware by, e.g., firmware, enabling interruption and resuming of operations. In one or more aspects, the instruction includes a flag bit to bypass reading and storing of state information on successful operation completion. In one or more aspects, the instruction includes a flag bit to specify meaning and usage of other flag bits to support optimized operation, as well as backwards compatibility to prior architecture versions.

In one or more aspects, a single architected instruction is provided that performs a hash operation using one or more flag bits to optimize processing on completion and/or interruption.

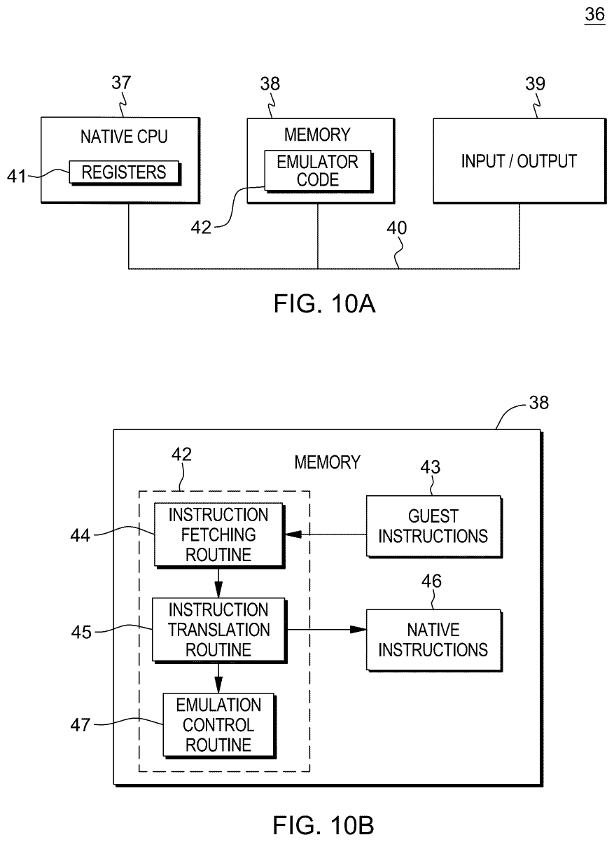

Although one or more examples of a computing environment to incorporate and use one or more aspects of the present disclosure are described herein, FIGS. 10A-10B depict another embodiment of a computing environment to incorporate and use one or more aspects of the present disclosure.

Referring, initially, to FIG. 10A, in this example, a computing environment 36 includes, for instance, a native central processing unit (CPU) 37 based on one architecture having one instruction set architecture, a memory 38, and one or more input/output devices and/or interfaces 39 coupled to one another via, for example, one or more buses 40 and/or other connections.

Native central processing unit 37 includes one or more native registers 41, such as one or more general purpose registers and/or one or more special purpose registers used during processing within the environment. These registers include information that represents the state of the environment at any particular point in time.

Moreover, native central processing unit 37 executes instructions and code that are stored in memory 38. In one particular example, the central processing unit executes emulator code 42 stored in memory 38. This code enables the computing environment configured in one architecture to emulate another architecture (different from the one architecture) and to execute software and instructions developed based on the other architecture.

Further details relating to emulator code 42 are described with reference to FIG. 10B. Guest instructions 43 stored in memory 38 comprise software instructions (e.g., correlating to machine instructions) that were developed to be executed in an architecture other than that of native CPU 37. For example, guest instructions 43 may have been designed to execute on a processor based on the other instruction set architecture, but instead, are being emulated on native central processing unit 37, which may be, for example, the one instruction set architecture. In one example, emulator code 42 includes an instruction fetching routine 44 to obtain one or more guest instructions 43 from memory 38, and to optionally provide local buffering for the instructions obtained. It also includes an instruction translation routine 45 to determine the type of guest instruction that has been obtained and to translate the guest instruction into one or more corresponding native instructions 46. This translation includes, for instance, identifying the function to be performed by the guest instruction and choosing the native instruction(s) to perform that function.

Further, emulator code 42 includes an emulation control routine 47 to cause the native instructions to be executed. Emulation control routine 47 may cause native central processing unit 37 to execute a routine of native instructions that emulate one or more previously obtained guest instructions and, at the conclusion of such execution, return control to the instruction fetch routine to emulate the obtaining of the next guest instruction or a group of guest instructions. Execution of the native instructions 46 may include loading data into a register from memory 38; storing data back to memory from a register; or performing some type of arithmetic or logic operation, as determined by the translation routine.

Each routine is, for instance, implemented in software, which is stored in memory and executed by native central processing unit 37. In other examples, one or more of the routines or operations are implemented in firmware, hardware, software or some combination thereof. The registers of the emulated processor may be emulated using registers 41 of the native central processing unit or by using locations in memory 38. In embodiments, guest instructions 43, native instructions 46 and emulator code 42 may reside in the same memory or may be disbursed among different memory devices.

An example instruction that may be emulated is the Compute Last Message Digest instruction described herein, in accordance with one or more aspects of the present disclosure.

The computing environments described herein are only examples of computing environments that can be used. One or more aspects of the present disclosure may be used with many types of environments. The computing environments provided herein are only examples. Each computing environment is capable of being configured to include one or more aspects of the present disclosure. For instance, each may be configured to implement accelerated and/or interruptible hash processing and/or to perform one or more other aspects of the present disclosure.

One or more aspects of the present disclosure are tied to computer technology and facilitate processing within a computer, improving performance thereof. For instance, processing speed is increased and performance is improved by selectively controlling one or more operations of the hash processing. The selectively controlling enables one or more operations to be bypassed, providing a savings of resources and improving processing speed. Processing within a processor, computer system and/or computing environment is improved.

Other aspects, variations and/or embodiments are possible.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer-readable code into a computing system, in which the code in combination with the computing system is capable of performing one or more embodiments.

Yet a further aspect, a process for integrating computing infrastructure comprising integrating computer-readable code into a computer system may be provided. The computer system comprises a computer-readable medium, in which the computer medium comprises one or more embodiments. The code in combination with the computer system is capable of performing one or more embodiments.

Although various embodiments are described above, these are only examples. For example, other instructions, instruction formats, operands and/or registers may be used. Further, other cryptographic algorithms may be used. Moreover, additional, less and/or other code may be used. Although particular code may be provided as an example of performing a particular operation or task, additional and/or other code may be used. Code may be combined and/or separated into code subsets. Many variations are possible.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer program product comprising:
a set of one or more computer-readable storage media; and
program instructions, collectively stored in the set of one or more computer-readable storage media, for causing at least one computing device to perform computer operations including:
executing an instruction to generate a message digest for a message, the message digest to be used in authentication of the message, the executing the instruction including:
obtaining from the instruction a control indicator;
determining, based on the control indicator, an initial chaining value to be used to generate the message digest;
generating the message digest using the initial chaining value; and
providing the message digest to be used in the authentication of the message.

2. The computer program product of claim 1, wherein the determining the initial chaining value comprises:
checking the control indicator; and
using a program provided initial chaining value as the initial chaining value, based on the control indicator being a selected value.

3. The computer program product of claim 2, wherein the determining the initial chaining value comprises using a default value as the initial chaining value, based on the control indicator being another selected value.

4. The computer program product of claim 1, wherein the message digest is an intermediate message digest for the message.

5. The computer program product of claim 1, wherein the message digest is a last message digest for the message.

6. The computer program product of claim 5, wherein the executing the instruction further includes controlling a storing of at least a part of an output chaining value produced in generating the last message digest based on another control indicator of the instruction.

7. The computer program product of claim 6, wherein the controlling the storing of the at least a part of the output chaining value includes selectively bypassing a storing the at least a part of the output chaining value based on the another control indicator being set to a selected value.

8. The computer program product of claim 6, wherein the controlling the storing of the at least a part of the output chaining value includes storing the at least a part of the output chaining value based on the another control indicator being set to another selected value.

9. The computer program product of claim 1, wherein the computer operations further include:
interrupting execution of the instruction; and
resuming execution of the instruction using at least one selected input of the instruction.

10. The computer program product of claim 9, wherein the at least one selected input is an output chaining value that is provided as an input to the instruction.

11. A computer system comprising:
at least one computing device;
a set of one or more computer-readable storage media; and
program instructions, collectively stored in the set of one or more computer-readable storage media, for causing the at least one computing device to perform computer operations including:
executing an instruction to generate a message digest for a message, the message digest to be used in authentication of the message, the executing the instruction including:
obtaining from the instruction a control indicator;
determining, based on the control indicator, an initial chaining value to be used to generate the message digest;
generating the message digest using the initial chaining value; and
providing the message digest to be used in the authentication of the message.

12. The computer system of claim 11, wherein the determining the initial chaining value comprises:
checking the control indicator; and
using a program provided initial chaining value as the initial chaining value, based on the control indicator being a selected value.

13. The computer system of claim 12, wherein the determining the initial chaining value comprises using a default value as the initial chaining value, based on the control indicator being another selected value.

14. The computer system of claim 11, wherein the message digest is an intermediate message digest for the message.

15. The computer system of claim 11, wherein the message digest is a last message digest for the message.

16. The computer system of claim 15, wherein the executing the instruction further includes controlling a storing of at least a part of an output chaining value produced in generating the last message digest based on another control indicator of the instruction, wherein the controlling the storing of the at least a part of the output chaining value includes selectively bypassing a storing the at least a part of the output chaining value based on the another control indicator being set to a selected value.

17. The computer system of claim 15, wherein the executing the instruction further includes controlling a storing of at least a part of an output chaining value produced in generating the last message digest based on another control indicator of the instruction, wherein the controlling the storing of the at least a part of the output chaining value includes storing the at least a part of the output chaining value based on the another control indicator being set to another selected value.

18. A computer-implemented method comprising:
executing an instruction to generate a message digest for a message, the message digest to be used in authentication of the message, the executing the instruction including:
obtaining from the instruction a control indicator;
determining, based on the control indicator, an initial chaining value to be used to generate the message digest;
generating the message digest using the initial chaining value; and
providing the message digest to be used in the authentication of the message.

19. The computer-implemented method of claim 18, wherein the determining the initial chaining value comprises:
checking the control indicator; and
using a program provided initial chaining value as the initial chaining value, based on the control indicator being a selected value.

20. The computer-implemented method of claim 19, wherein the determining the initial chaining value comprises using a default value as the initial chaining value, based on the control indicator being another selected value.

21. The computer-implemented method of claim 18, wherein the message digest is an intermediate message digest for the message.

22. The computer-implemented method of claim 18, wherein the message digest is a last message digest for the message.

23. The computer-implemented method of claim 18, wherein the executing the instruction further includes controlling a storing of at least a part of an output chaining value produced in generating the last message digest based on another control indicator of the instruction.

24. A computer program product comprising:
a set of one or more computer-readable storage media; and
program instructions, collectively stored in the set of one or more computer-readable storage media, for causing at least one computing device to perform computer operations including:
executing an instruction to generate a message digest for a message, the instruction including a flags field having at least one control indicator, an address of the message, and a function code to specify a function of the instruction to be performed, the function being a specific hash technique to generate the message digest, the message digest to be used in authentication of the message, the executing the instruction including:
obtaining from the instruction a control indicator of the at least one control indicator;
determining, based on the control indicator, an initial chaining value to be used to generate the message digest for the message specified by the instruction;
generating the message digest using the initial chaining value; and
providing the message digest to be used in the authentication of the message.

25. A computer-implemented method comprising:
executing an instruction to generate a message digest for a message, the instruction including a flags field having at least one control indicator, an address of the message, and a function code to specify a function of the instruction to be performed, the function being a specific hash technique to generate the message digest, the message digest to be used in authentication of the message, the executing the instruction including:
obtaining from the instruction a control indicator of the at least one control indicator;
determining, based on the control indicator, an initial chaining value to be used to generate the message digest for the message specified by the instruction;
generating the message digest using the initial chaining value; and
providing the message digest to be used in the authentication of the message.
